(19) United States
(12) Patent Application Publication
(10) Pub. No.: US 2006/0230619 A1
(43) Pub. Date: Oct. 19, 2006

(54) Hair clipper with vacuum collection system

(75) Inventors: Eric J. Williams, Verona, WI (US); Angelo J. Rainone, Wolcott, CT (US); James J. Kennedy III, Deerfield, NH (US)

Correspondence Address: SENNIGER POWERS, ONE METROPOLITAN SQUARE, 16TH FLOOR, ST LOUIS, MO, 63102, US

(73) Assignee: Rovcal, Inc., Madison, WI (US)

(21) Appl. No.: 11/108,513

(22) Filed: Apr. 18, 2005

(51) Int. Cl. B26B 19/44

(52) U.S. Cl. 30/133

(57) ABSTRACT

Hand-held apparatus for clipping hair including a self-contained vacuum source for collection of hair clippings. The apparatus comprises a housing. An airway extends within the housing from an inlet to an exhaust. A vacuum source is disposed in the airway intermediate the inlet and the exhaust and operates to draw air into the housing through said inlet. A cutting assembly comprising at least one cutting blade is disposed exterior of the airway in spaced relationship with the housing inlet such that hair clippings produced by the cutting assembly are drawn through the housing inlet into the airway. A filter member is disposed in the airway between the inlet and the vacuum source to inhibit hair clippings that have been drawn into the airway from flowing to the vacuum source. Various metrics are disclosed that can be used individually or in combination to improve performance of the apparatus.

### FIELD OF INVENTION

This invention relates generally to apparatus for clipping hair, particularly longer hair such as the hair on one's head, and more particularly to hand-held hair clipping apparatus having a self-contained vacuum system for collecting hair clippings during use.

### BACKGROUND

Hand-held hair clippers have been used to cut hair in barber shops and private homes for many years. For example, hair clippers are commonly used to cut the hair on one's head, to trim moustaches and beards, and to cut animal hair. Such hair clippers typically comprise a housing sized and shaped to be held comfortably in one hand, and a cutting assembly mounted at one end of the housing. The cutting assembly commonly comprises a stationary toothed blade and a reciprocating toothed blade slidably mounted adjacent the stationary blade and driven back and forth by a motor enclosed in the housing. A comb may be mounted on the end of the housing to guide hair into the cutting assembly and to generally control the length of the cut.

The hair clippings produced by many conventional hair clippers simply fall away from the apparatus onto the person or animal whose hair is being cut or are otherwise scatter about the work area. To this end, other hair clippers have been designed to operate in conjunction with an external vacuum system for collecting the hair clippings as the hair cutting is performed. This can reduce the amount of cleaning needed after the cut is finished. As an example, U.S. Pat. No. 5,088,199 discloses an attachment adapted for connection to an ordinary vacuum (e.g., a household vacuum cleaner) through a suction hose. The attachment includes a suction head defining an airflow passage in fluid communication with the suction hose. The suction head is adapted to be fastened to an ordinary pair of hair clippers so the inlet of the airflow passage is adjacent the cutting assembly of the clippers. The vacuum is used to draw clippings produced by clippers into the suction hose.

Still other prior art hand-held hair clippers have been designed with internal (e.g., on-board) vacuum sources, thereby avoiding the need for a suction hose attached to the hand-held part of the device. One example is disclosed in U.S. Pat. No. 2,323,046. The apparatus disclosed in the '046 patent comprises a hollow hand-held housing defining an airway having an inlet adjacent the cutting assembly and an outlet leading into a filter bag. A fan is mounted in the housing to draw air and hair clippings in through the inlet and blow them into the filter bag after they have passed by the fan. The apparatus disclosed in the '046 patent employs what is referred to as a “dirty-air” vacuum system, meaning that hair clippings and debris are not filtered out of the airstream before the airstream reaches the fan. Thus, hair clippings and other debris drawn through the inlet are more likely to stick to the fan blades and reduce the fan's efficiency. There is also greater risk that unfiltered dust and debris may work its way into the motor's housing and interfere with operation of the motor. Moreover, if large clumps of hair clippings are drawn into the fan, operation of the fan could be obstructed. This may limit the type of hair that can be cut with clippers having a dirty-air vacuum system for collection of the clippings.

To this end, it is known to construct a hair clipping apparatus to have a “clean-air” vacuum system in which debris (e.g., hair clippings) is filtered out of the airstream before it reaches the vacuum source. One potential drawback with using a clean-air vacuum systems is that the clippings can accumulate on the filter and obstruct airflow, thereby reducing the effective vacuum power of the apparatus.

Some efforts have been directed at countering the tendency of the filter of a clean-air vacuum system to get plugged with hair clippings. For example, U.S. Pat. No. 6,739,053 discloses a beard and mustache trimmer comprising a housing that defines an airway extending from an inlet to an exhaust. A vacuum source is mounted in the airway downstream of a hairpin turn. A filter is mounted downstream of the hairpin turn and upstream of the vacuum source to prevent hair clippings from entering the vacuum source. As the airflow and entrained hair clippings change direction at the hairpin turn, gravity and centrifugal forces tend to cause the hair clippings to fall out of the air stream into a collection area. The accumulation of hair clippings in the collection area is less of an obstruction to airflow than would result if all the clippings were allowed to accumulate on the filter, but the airflow through the airway is much less efficient because of the hairpin turn.

There is need, therefore, for an improved hair clipper capable of clipping and collecting relatively long hairs and utilizing a clean-air vacuum system.

### SUMMARY

One embodiment of the invention is a hand-held apparatus for clipping hair. The apparatus comprises a housing having an upstream end and a downstream end. The housing further comprises an inlet at the upstream end for receiving air and hair clippings into the housing and an exhaust downstream of the inlet for exhausting air from the housing. An airway extends within the housing from the inlet to the exhaust for directing air flow through the housing. A vacuum source is disposed in the airway intermediate the inlet and the exhaust. The vacuum source defines a flow path along the airway through which air flows generally in the direction of the flow path from the housing inlet to the vacuum source. The vacuum source is operable to draw air into the housing through the inlet and along the airway including the flow path for subsequent exhaustion from the housing through the exhaust. A cutting assembly comprising at least one cutting blade is disposed exterior of the airway in spaced relationship with the housing inlet such that hair clippings produced by the cutting assembly are drawn through the housing inlet into the airway for flow along the flow path toward the vacuum source. A filter member is disposed in the airway along the flow path between the inlet and the vacuum source to inhibit hair clippings that have been drawn into the airway from flowing to the vacuum source. The housing inlet has a cross-sectional area and the flow path between the inlet and the vacuum source has a maximum cross-sectional area downstream of the inlet. The maximum cross-sectional area of the flow path is greater than the cross-sectional area of the inlet. The housing has a cross-sectional area at the maximum cross-sectional area of the flow path. The ratio of the maximum cross-sectional area of the flow path to the cross-sectional area of the housing at the maximum cross-sectional area of the flow path is at least about 0.5.

Another embodiment of the invention is a hand-held apparatus for clipping hair comprises a housing having an upstream end and a downstream end. The housing further comprises an inlet at the upstream end for receiving air and hair clippings into the housing and an exhaust downstream of the inlet for exhausting air from the housing. An airway extends within the housing from the inlet to the exhaust for directing air flow through the housing. A vacuum source is disposed in the airway intermediate the inlet and the exhaust. The vacuum source defines a flow path along the airway through which air flows generally in the direction of the flow path from the housing inlet to the vacuum source. The vacuum source is operable to draw air into the housing through the inlet and along the airway including the flow path for subsequent exhaustion from the housing through the exhaust. A cutting assembly comprising at least one cutting blade is disposed exterior of the airway in spaced relationship with the housing inlet such that hair clippings produced by the cutting assembly are drawn through the housing inlet into the airway for flow along the flow path toward the vacuum source. A filter member is disposed in the airway along the flow path between the inlet and the vacuum source to inhibit hair clippings that have been drawn into the airway from flowing to the vacuum source. The housing inlet has a cross-sectional area and the flow path of the airway has a maximum cross-sectional area downstream of the inlet. The maximum cross-sectional area of the flow path is greater than the cross-sectional area of the housing inlet. The housing has a length. The ratio of the maximum cross-sectional area of the flow path to the length of the housing is at least about 0.5 cm²/cm.

Another hand-held apparatus for clipping hair of the present invention includes a housing having an upstream end and a downstream end. The housing further comprises an inlet at the upstream end for receiving air and hair clippings into the housing and an exhaust downstream of the inlet for exhausting air from the housing. An airway extends within the housing from the inlet to the exhaust for directing air flow through the housing. A vacuum source is disposed in the airway intermediate the inlet and the exhaust. The vacuum source defines a flow path along the airway through which air flows from the housing inlet to the vacuum source. The vacuum source comprises a vacuum fan having a diameter and is operable to draw air into the housing through the inlet and along the airway including the flow path for exhaustion from the housing through the exhaust. A cutting assembly comprising at least one cutting blade is disposed exterior of the airway in spaced relationship with the housing inlet such that hair clippings produced by the cutting assembly are drawn through the housing inlet into the airway for flow along the flow path toward the vacuum source. A filter member is disposed in the airway along the flow path between the inlet and the vacuum source to inhibit hair clippings that have been drawn into the airway from flowing to the vacuum source. The housing inlet has a cross-sectional area and the flow path of the airway has a maximum cross-sectional area downstream of the inlet. The maximum cross-sectional area of the flow path is greater than the cross-sectional area of the inlet. The ratio of the maximum cross-sectional area of the flow path to the cross sectional area of the vacuum fan is at least about 0.7.

Yet another embodiment of the invention is a hand-held apparatus for clipping hair comprising a housing having an upstream end and a downstream end. The housing further comprise an inlet at the upstream end for receiving air and hair clippings into the housing and an exhaust downstream of the inlet for exhausting air from the housing. An airway extends within the housing from the inlet to the exhaust for directing air flow through the housing. A vacuum source is disposed in the airway intermediate the inlet and the exhaust. The vacuum source defines a flow path along the airway through which air flows generally in the direction of the flow path from the housing inlet to the vacuum source. The vacuum source is operable to draw air into the housing through the inlet and along the airway including the flow path for subsequent exhaustion from the housing through the exhaust. A cutting assembly comprising at least one cutting blade is disposed exterior of the airway in spaced relationship with the housing inlet such that hair clippings produced by the cutting assembly are drawn through the housing inlet into the airway for flow along the flow path toward the vacuum source. A filter member is disposed in the airway along the flow path between the inlet and the vacuum source to inhibit hair clippings that have been drawn into the airway from flowing to the vacuum source. The housing inlet has a cross-sectional area and the flow path of the airway has a maximum cross-sectional area downstream of the inlet. The maximum cross-sectional area of the flow path is greater than the cross-sectional area of the inlet. The flow path has a median line extending therethrough along the flow path from the inlet to the vacuum source. The median line is free from deviations of more than about 60 degrees along the flow path. The flow path of the airway defines a volume and the housing defines a displacement. The ratio of the flow path volume to the housing displacement being at least about 0.25.

Another hand-held apparatus for clipping hair of the present invention comprises a housing having an upstream end and a downstream end. The housing further comprises an inlet at the upstream end for receiving air and hair clippings into the housing and an exhaust downstream of the inlet for exhausting air from the housing. An airway extends within the housing from the inlet to the exhaust for directing air flow through the housing. A vacuum source is disposed in the airway intermediate the inlet and the exhaust. The vacuum source defines a flow path along the airway through which air flows generally in the direction of the flow path from the housing inlet to the vacuum source. The vacuum source is operable to draw air into the housing through the inlet and along the airway including the flow path for subsequent exhaustion from the housing through the exhaust. A cutting assembly comprising at least one cutting blade is disposed exterior of the airway in spaced relationship with the housing inlet such that hair clippings produced by the cutting assembly are drawn through the housing inlet into the airway for flow along the flow path toward the vacuum source. A filter member is disposed in the airway along the flow path between the inlet and the vacuum source to inhibit hair clippings that have been drawn into the airway from flowing to the vacuum source. The filter member is configured to define an interior pocket of the filter member for collecting and retaining hair clippings. The filter member is removable from the housing for emptying hair clippings from the pocket. The pocket of the filter member has a maximum cross-sectional area along the flow path. The housing inlet has a cross-sectional area. The maximum cross-sectional area of the filter member pocket along the flow path is greater than the cross-sectional area of the housing inlet. The housing has a cross-sectional area at the maximum cross-sectional area of the filter member pocket. The ratio of the maximum cross-sectional area of the filter member pocket to the cross-sectional area of the housing at the maximum cross-sectional area of the filter member pocket is at least about 0.40.

Still another embodiment of the invention is a hand-held apparatus for clipping hair comprising a housing having an upstream end and a downstream end. The housing further comprises an inlet at the upstream end for receiving air and hair clippings into the housing and an exhaust downstream of the inlet for exhausting air from the housing. An airway extends within the housing from the inlet to the exhaust for directing air flow through the housing. A vacuum source is disposed in the airway intermediate the inlet and the exhaust. The vacuum source defines a flow path along the airway through which air flows generally in the direction of the flow path from the housing inlet to the vacuum source. The vacuum source is operable to draw air into the housing through the inlet and along the airway including the flow path for subsequent exhaustion from the housing through the exhaust. The flow path of the airway has a median line extending along the flow path from the inlet to the vacuum source. The median line is free from deviations of more than about 60 degrees along the flow path. A cutting assembly comprising at least one cutting blade is disposed exterior of the airway in spaced relationship with the housing inlet such that hair clippings produced by the cutting assembly are drawn through the housing inlet into the airway for flow along the flow path toward the vacuum source. A filter member is disposed in the airway along the flow path between the inlet and the vacuum source to inhibit hair clippings that have been drawn into the airway from flowing to the vacuum source. The filter member is configured to define an interior pocket of the filter member for collecting the hair clippings. The filter member is removable from the housing for emptying hair clippings from the pocket and is constructed and arranged in the flow path such that air flowing along the flow path flows into the filter member pocket generally in the direction of the flow path. The filter member is further configured to permit a portion of air that flows into the interior pocket of the filter member to pass out through the filter member generally in the direction of the flow path and to permit another portion of air that flows into the interior pocket of the filter member to pass out through the filter member generally in a direction transverse to the direction of the flow path.

Another embodiment of the invention is a hand-held apparatus for clipping hair comprising a housing having an upstream end and a downstream end. The housing comprises an inlet at the upstream end for receiving air and hair clippings into the housing and an exhaust downstream of the inlet for exhausting air from the housing. An airway extending within the housing from the inlet to the exhaust for directing air flow through the housing. A vacuum source is disposed in the airway intermediate the inlet and the exhaust. The vacuum source defines a flow path along the airway through which air flows generally in the direction of the flow path from the housing inlet to the vacuum source. The vacuum source is operable to draw air into the housing through the inlet and along the airway including the flow path for subsequent exhaustion from the housing through the exhaust. A cutting assembly comprising at least one cutting blade is disposed exterior of the airway in spaced relationship with the housing inlet such that hair clippings produced by the cutting assembly are drawn through the housing inlet into the airway for flow along the flow path toward the vacuum source. A filter member is disposed in the airway along the flow path between the inlet and the vacuum source to inhibit hair clippings that have been drawn into the airway from flowing to the vacuum source. The filter member is configured to define an interior pocket of the filter member for collecting and retaining hair clippings therein. The filter member is removable from the housing for emptying hair clippings from the pocket. A compaction device is operable within the flow path of the airway to at least one of selectively and intermittently compact hair clippings collected and retained in the interior pocket of the filter member.

Another embodiment of a hand-held apparatus for clipping hair of the present invention comprises a housing having an upstream end and a downstream end. The housing further comprises an inlet at the upstream end for receiving air and hair clippings into the housing and an exhaust downstream of the inlet for exhausting air from the housing. An airway extends within the housing from the inlet to the exhaust for directing air flow through the housing. A vacuum source is disposed in the airway intermediate the inlet and the exhaust. The vacuum source defines a flow path along the airway through which air flows generally in the direction of the flow path from the housing inlet to the vacuum source the vacuum source is operable to draw air into the housing through the inlet and along the airway including the flow path for subsequent exhaustion from the housing through the exhaust. A cutting assembly comprising at least one cutting blade is disposed exterior of the airway in spaced relationship with the housing inlet such that hair clippings produced by the cutting assembly are drawn through the housing inlet into the airway for flow along the flow path toward the vacuum source. A filter member is disposed in the airway along the flow path between the inlet and the vacuum source to inhibit hair clippings that have been drawn into the airway from flowing to the vacuum source. The filter member is configured to define an interior pocket of the filter member for collecting and retaining hair clippings therein. The filter member is removable from the housing for emptying hair clippings from the pocket. The housing defines a displacement and the interior pocket of the filter member has a volume. The ratio of the volume of the interior pocket of the filter member to the displacement of the housing is at least about 0.2.

### BRIEF DESCRIPTION OF THE DRAWINGS

FIG. 1 is a perspective view of one embodiment of a hand-held hair clipping apparatus of the present invention;

FIG. 2 is a plan view of the apparatus of FIG. 1;

FIG. 3 is a cross section of the apparatus of FIGS. 1 and 2 taken in the plane of line 3-3 of FIG. 2;

FIG. 4 is a perspective view of the cross sectioned apparatus of FIG. 3;

FIG. 5 is a cross section similar to FIG. 3 with a series of circles inscribed in an airway of the apparatus for use in determining a median line of the airway;

FIG. 6 is a perspective view of the apparatus of FIG. 1 with a removable portion of the apparatus shown exploded therefrom;

FIG. 7 is a perspective view of a filter member of the apparatus for collecting hair clippings;

FIG. 8 is a cross section of a second embodiment of a hand-held hair clipping apparatus of the present invention;

FIG. 9 is a cross section similar to FIG. 8 showing a compaction device of the hair clipping apparatus as air flows through an airway of the apparatus;

FIG. 10 is a perspective view of the cross section of FIG. 9;

FIGS. 11-14 are cross sections similar to FIGS. 8 and 9 illustrating a sequence of operation of the compaction device;

FIG. 15 is a side elevation of the apparatus of FIGS. 1-7;

FIG. 15A is a cross-section of a flow path of the apparatus taken in the plane of line 15A-15A of FIG. 15;

FIG. 15B is a cross-section of the flow path of the apparatus taken in the plane of line 15B-15B of FIG. 15; and

FIG. 15C is a cross-section of the apparatus taken in the plane of line 15C-15C of FIG. 15 showing the relative cross sectional areas of the flow path and the apparatus.

Corresponding reference characters indicate corresponding parts throughout the drawings.

### DETAILED DESCRIPTION

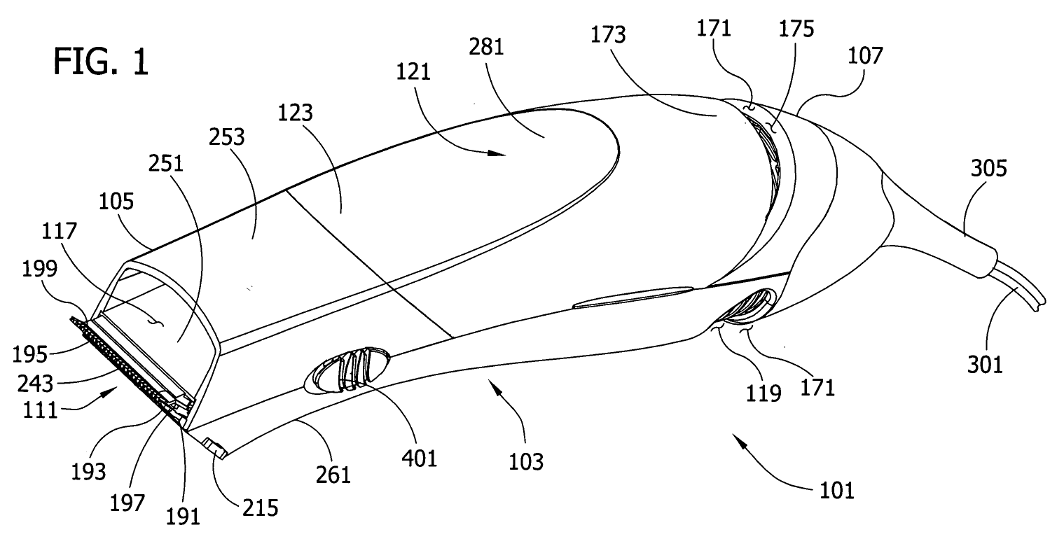

Referring now to the drawings and in particular to FIG. 1, a hand-held apparatus according to one embodiment of the present invention for clipping hairs is generally designated 101. The hair clipping apparatus is particularly constructed for use in cutting relatively longer hairs, e.g., that result in hair clippings of a length greater than about 0.5 inches. However, it is understood that the hair clipping apparatus 101 may be used to cut shorter lengths and remain within the scope of the invention. The apparatus 101 generally comprises a housing 103 having an upstream end 105 and a downstream end 107 (the terms upstream and downstream referring to the general direction in which air flows through the housing as will be described), a vacuum source 109 disposed in the housing generally adjacent the downstream end thereof, and a cutting assembly 111 extending at least in part outward beyond the upstream end of the housing for cutting hair to produce hair clippings.

The housing 103 has an interior airway 115 extending from a housing inlet 117 disposed generally at the upstream end 105 of the housing to an exhaust 119 generally adjacent the downstream end 107 of the housing and in particular downstream of the vacuum source 109. The housing 103 is suitably sized and shaped for being held in one hand. In a particularly suitable embodiment, all or part of the housing 103, and in particular those portions of the housing that in part define the interior airway 115, are constructed of a translucent or transparent material so that the user can monitor the flow and collection of hair clippings in the airway. The translucent or transparent portions of the housing 103 also provide the user with a better view of the cutting assembly during hair clipping.

The housing 103 suitably comprises an access panel 121 that is releasably secured to the housing, particularly downstream of the housing inlet 117 and along the interior airway 115, to permit access to the interior airway to empty hair clippings from the apparatus 101. In the illustrated embodiment, the access panel 121 in part defines the interior airway 115 of the housing. In particular, an upstream end 123 of the access panel 121 overlays a recessed portion 125 of the housing 103 to inhibit air against leaking from the interior airway 115. The access panel 121 has a plurality of detents 131 that snap-fit into corresponding recesses 133 formed in the housing 103 to releasably secure the access panel on the housing 103. It is understood, however, that other suitable releasable fastening techniques may be used to releasably secure the access panel 121 on the housing 103 without departing from the scope of this invention.

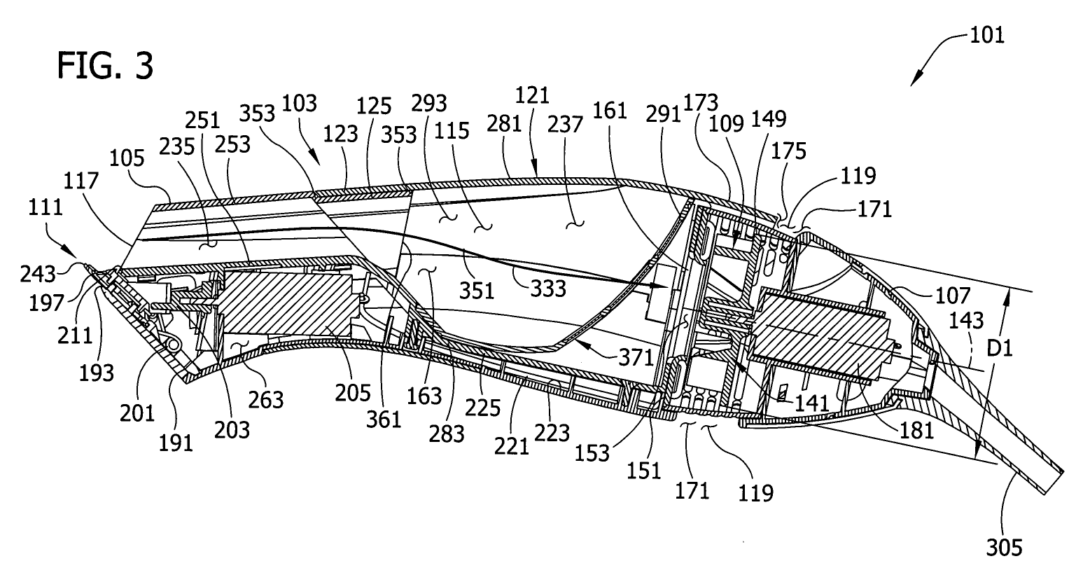

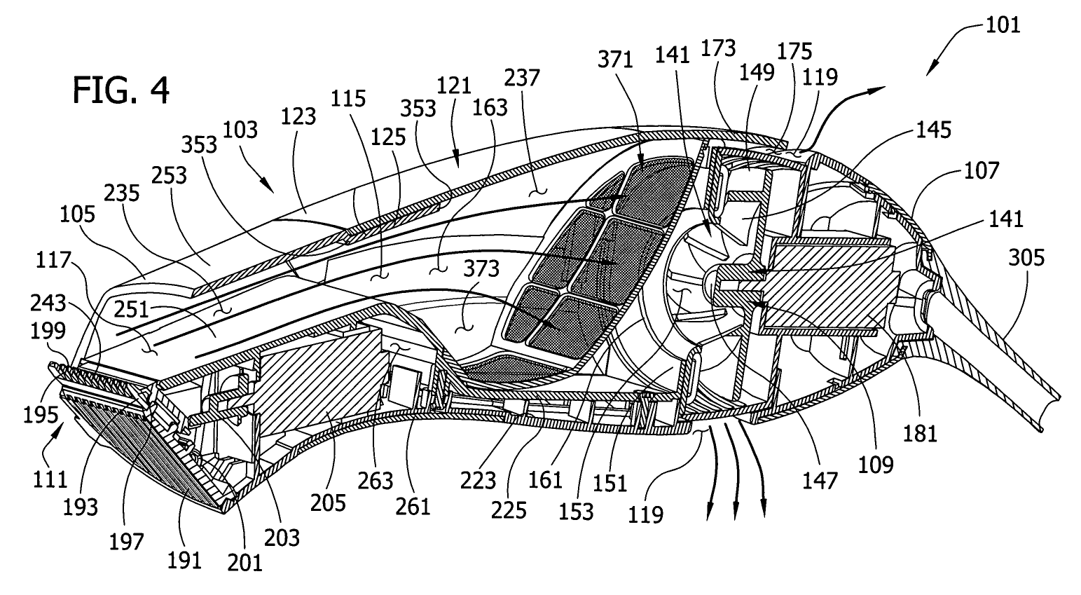

The vacuum source 109 suitably comprises a centrifugal fan 141 mounted in the airway 115 generally toward the downstream end 107 of the housing 103. The fan 141 is rotatable about a rotation axis 143 oriented generally parallel to the airway 115 upstream of the fan. A plurality of vanes 145 extend radially outward from generally near the center 147 of the fan 141 toward its peripheral edge 149. The vanes 145 are suitably configured such that rotation of the fan 141 about its rotation axis 143 draws air into the housing 103 at the housing inlet 117 and through the interior airway 115 to the fan. In the illustrated embodiment of FIGS. 3 and 4, a separator panel 151 is disposed within the housing 103 upstream of the fan 141 and has a central opening 153 defining part of the airway 115 to permit air in the airway upstream of the fan 141 to flow through the separator panel 151 to the fan.

The separator panel 151 defines a downstream end 161 of a flow path 163 of the airway 115 in which air flows from the housing inlet 117 to the vacuum source 109 generally in the direction of the flow path. As an example, the central opening 153 of the separator panel 151 may suitably have a cross-sectional area in the range of about 1.25 cm² to about 11.5 cm², and more suitably in the range of about 2.5 cm² to about 7.5 cm², and even more suitably in the range of about 4.5 cm² to about 5.5 cm². It is understood, however, that the separator panel 151 may be omitted without departing from the scope of this invention, in which instance the flow path 163 would be defined as the portion of the airway 115 that extends from the housing inlet 117 to the most upstream (in the direction of the flow path) portion of the vacuum source 109 (e.g., the fan).

The fan 141 of the illustrated embodiment is suitably located adjacent the housing exhaust 119. However, the exhaust may be spaced farther from the fan 141 without departing from the scope of this invention. In particular, a plurality of openings 171 are formed in the housing 103 radially around at least a portion of the fan's peripheral edge 149 to form the housing exhaust 119. The exhaust 119 may suitably be partially covered by a portion of the housing 103, such as an extended portion 173 of the access panel 121 as shown in FIG. 3, to guide the direction of air flowing from the exhaust 119. For example, the hand-held hair clipping apparatus 101 of the illustrated embodiment is held by the user during hair clipping with the access panel 121 generally facing up toward the user (e.g., toward the arm and hand used to hold the apparatus and toward the user's face thereabove). The extended portion 173 of the access panel 121 covering the upward facing portion 175 of the exhaust 119 directs air exhausted from the housing 103 away from the user's face.

The fan 141 is operatively driven by an electric motor 181 disposed within the downstream end 107 of the housing 103. The motor 181 may suitably be powered by an external power source (e.g., through a conventional power cord, such as the power cord 301 surrounded in part by a suitable boot 305 at the downstream end of the housing 103) or by one or more batteries (e.g., one or more rechargeable batteries, not shown) stored within the housing 103. In a particularly suitable embodiment, the motor 181 is tuned to operate at a relatively high speed, such as at least about 7,500 rpm and more suitably in the range of about 7,500 rpm to about 20,000 rpm, for driving operation of the fan 141. The vacuum source 109 (together with the sizing of the housing inlet 117 and airway 115 as described in further detail later herein) is suitably sized for providing a vacuum pressure sufficient to draw relatively longer (and hence heavier) hair into the housing 103 via the housing inlet. As an example, where the vacuum source 109 is a fan such as the fan 141 illustrated in FIG. 3, the fan may suitably have a diameter D1 in the range of about 0.85 inches (about 2.2 cm) to about 2.0 inches (about 5.1 cm). As another example, the fan 141 of the illustrated embodiment suitably has a diameter D1 of about 1.7 inches (about 4.3 cm).

In one embodiment, the vacuum source 109 is suitably operable to produce at least about 5.0 cf/hr (about 0.14 cubic meters/hr) of airflow through the airway 115, more suitably in the range of about 5.0 cf/hr (about 0.14 cubic meters/hr) to about 18.0 cf/hr (about 0.51 cubic meters/hr) of airflow through the airway, still more suitably in the range of about 10 cf/hr (about 0.28 cubic meters/hr) to about 18 cf/hr (about 0.51 cubic meters/hr) of airflow through the airway, and even more suitably in the range of about 15 cf/hr (about 0.42 cubic meters/hr) to about 18 cf/hr (about 0.51 cubic meters/hr) of airflow through the airway. As another example, the vacuum source 109 is suitably powerful enough to generate a pressure difference between the housing inlet 117 and the exhaust 119 of at least about 0.4 inches (about 1 cm) of water, more suitably at least about 1.1 inches (about 2.8 cm) of water, and even more suitably at least about 2 inches (about 5.1 cm) of water.

It is also understood that the vacuum source 109 may comprise other suitable fans, such as without limitation an axial-flow fan, without departing from the scope of the invention. The vacuum source 109 may also be other than a fan unit, such as an air pump (e.g., a diaphragm pump).

The cutting assembly 111 comprises a mounting plate 191, a fixed or stationary cutting blade 193 secured to the mounting plate and having cutting teeth 195 extending outward beyond the mounting plate, and a reciprocating cutting blade 197 slidably mounted on the mounting plate adjacent the stationary cutting blade. In particular, the reciprocating cutting blade 197 has cutting teeth 199 held in contact with the cutting teeth 195 of the stationary cutting blade 193 by a suitable spring assembly 201. The spring assembly 201 allows transverse sliding movement of the reciprocating cutting blade 197 relative to the stationary cutting blade 193 so that the cutting teeth 199 of the reciprocating blade repeatedly move across the cutting teeth 195 of the stationary blade to cut hairs that enter the teeth of the blades. The reciprocating blade 197 is drivingly connected by a suitable drive connection member 203 to an electric motor 205 disposed within the upstream end 105 of the housing 103. The mounting plate 191 and the drive connection member 203 are configured for releasable connection with the housing 103 and motor 205, respectively, to permit removal of the cutting assembly 111 from the apparatus 101 for cleaning or replacement. Construction and operation of the cutting assembly 111 and corresponding electric motor 205 are known in the art and will not be described further herein except to the extent necessary to disclose the present invention.

The housing 103 is suitably configured at its upstream end 105 such that the cutting blades 193, 197 and inlet 117 are angled relative to each other as illustrated in FIG. 3. In particular, the housing inlet 117 is angled outward from the upstream most extent 211 of the housing 103. The cutting assembly 111 also angles outward from the upstream most extent 211 of the housing 103, but in transverse direction opposite the transverse direction in which the housing inlet 117 angles outward. Accordingly, the cutting blades 193, 197 are positioned exterior of the airway 115 in spaced relationship with the housing inlet 117. Such an arrangement provides the user with greater visibility of the cutting blades 193, 197 during operation of the apparatus 101 to cut hair, and also positions the blades 193, 197 generally in the line of the air flow path into the interior airway 115 of the housing 103 via the housing inlet 117.

Tabs 215 are suitably be formed on the housing 103 adjacent the cutting assembly 111 for mounting a conventional comb (not shown) to guide hairs into the cutting assembly 111 and to generally control the length at which the hairs are cut. Although the drawings all depict the same conventional cutting assembly 111, it is contemplated that any cutting assembly operable to cut hairs can be mounted adjacent the inlet 117 without departing from the scope of this invention.

The electric motor 205 used to drive the cutting assembly 111 may be powered by the same power source (external or internal) used to power the vacuum source 109. For example, in the illustrated embodiment of FIG. 3, suitable wiring 221 extends from the downstream end 107 of the housing 103, in communication with the power source, upstream along the inner surface 223 of the housing to the cutting assembly motor 205. A cover plate 225 is secured to the inner surface 221 of the housing 103 to protect the wiring 221 within the housing. It is contemplated, however, that separate power sources may be used to respectively operate the vacuum source 109 and cutting assembly 111 without departing from the scope of this invention.

In one embodiment, the cutting assembly motor 205 is particularly tuned for operating at a speed suitable for the cutting assembly 111. For example, in a particularly suitable embodiment the operating speed of the cutting assembly motor 205 may be different from, and more suitably less than, the operating speed of the vacuum source motor 181. As a further example, the operating speed of the cutting assembly motor 205 may suitably be in the range of about 6,000 rpm to about 9,000 rpm, and more suitably about 7,500 rpm.

Providing a cutting assembly motor 205 that is separate from the vacuum source motor 181 reduces the risk that the vacuum source 109 (e.g., in the illustrated embodiment, the vacuum fan 141) will slow down (resulting in reduced vacuum power) when the load on the motor 205 driving the cutting assembly 111 is increased. For example, if the cutting assembly 111 encounters a particularly thick clump of hair the motor 205 driving the cutting assembly may get bogged down by the increased power load. Concurrently, cutting the clump of hair will create a surge in the number of hair clippings to be drawn into the airway 115, making it a particularly undesirable time to experience diminished vacuum power. By using separate motors 205, 181 to drive the cutting assembly 111 and vacuum source 109, any negative effect experienced by the cutting assembly motor 205 has little effect on the vacuum source motor 181 (and hence the vacuum pressure). It is understood, however, that the cutting assembly 111 and vacuum source 109 may be powered by a single electric motor without departing from the scope of the invention.

With particular reference now to FIG. 3, using two separate motors 181, 205 for the vacuum source 109 and cutting assembly 111, and in particular by placing the cutting assembly within the upstream end 105 of the housing 103 immediately adjacent the cutting assembly, also reduces the amount of interior housing 103 space required for gearing that would otherwise extend from the vacuum source motor 181 upstream within the housing 103 to the cutting assembly 111. Accordingly, an increased amount of interior spacing within the housing 103 is available for forming an enlarged airway 115. For example, as illustrated in FIG. 3, the interior airway 115, and more particularly the flow path 163 of the airway extending downstream from the housing inlet 117 up to the vacuum source 109. In particular, the flow path 163 has what is referred to herein as a relatively narrow inlet chute 235 extending from the housing inlet 117 downstream within the housing 103 and opening into an enlarged portion of the flow path, the enlarged portion being referred to herein as a collection chamber 237.

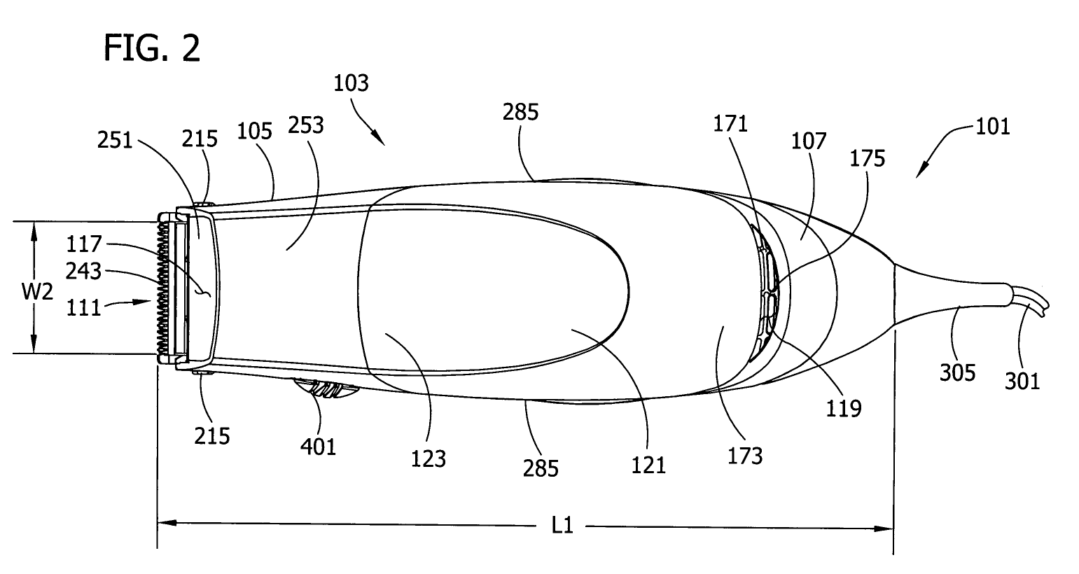

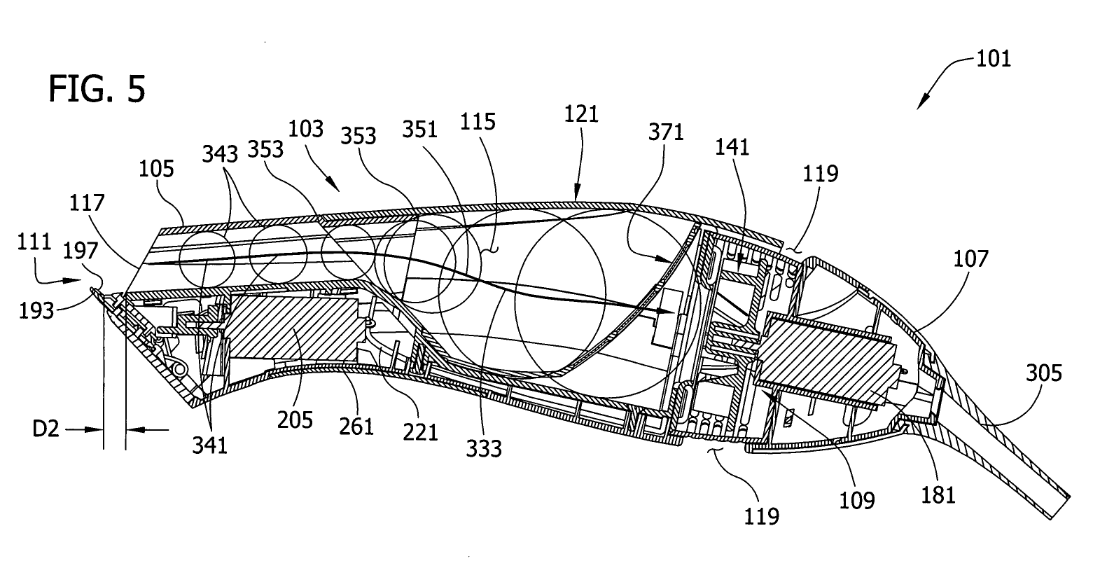

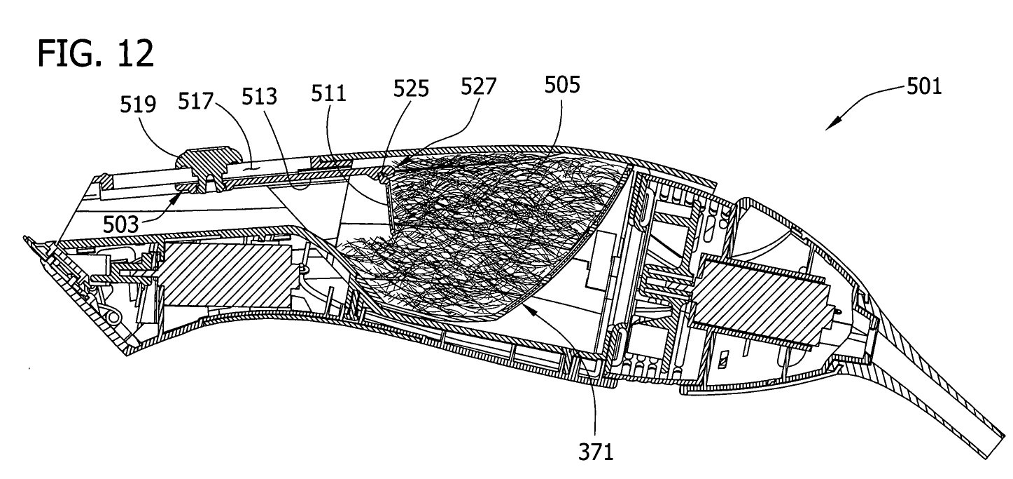

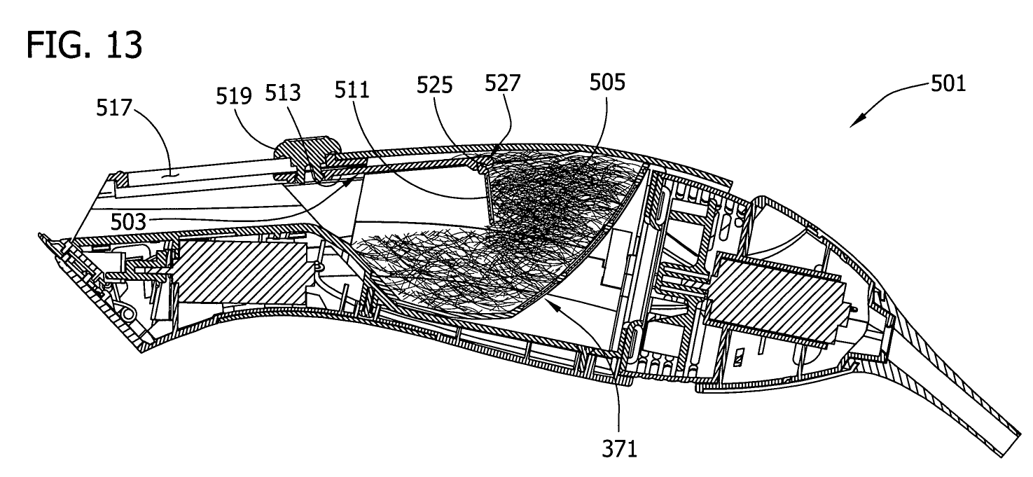

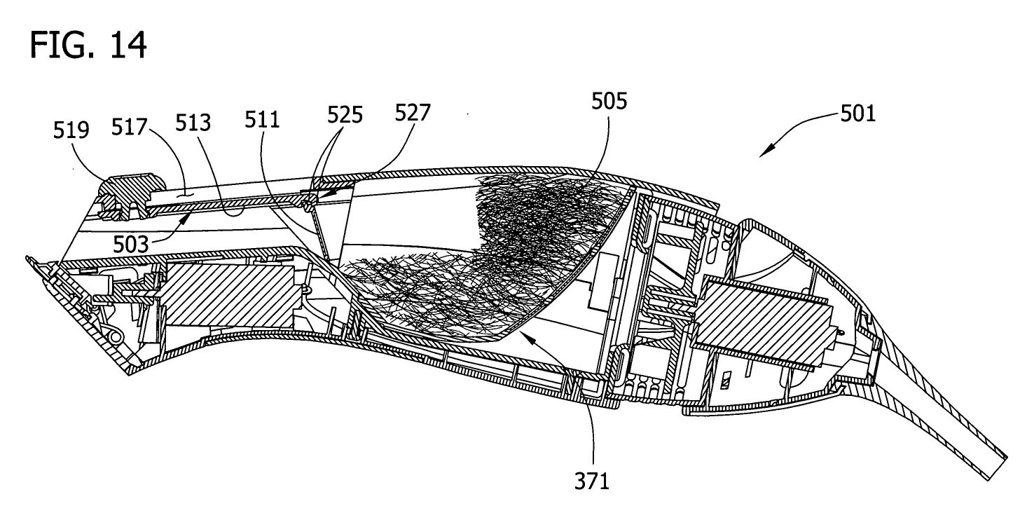

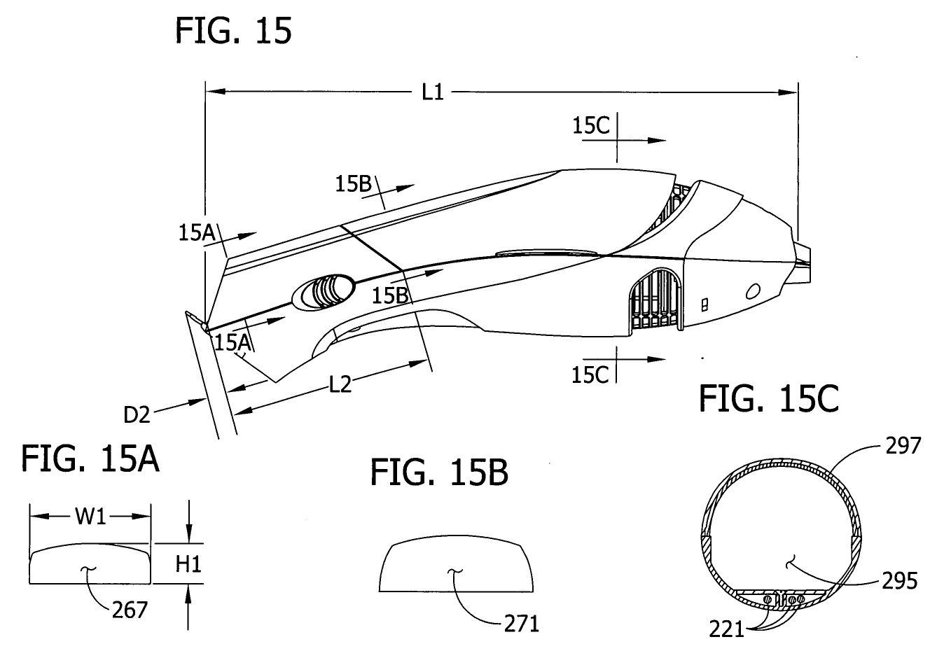

The inlet 117 is suitably spaced apart from the end 243 of the cutting assembly 111 a distance D2 (FIG. 5) between about 0.1 inches (about 0.25 cm) and about 0.5 inches (about 1.27 cm), more suitably between about 0.25 (about 0.64 cm) and about 0.5 inches (about 1.27 cm), and even more suitably between about 0.3 inches (about 0.76 cm) and about 0.45 inches (about 1.1 cm). The width W1 of the inlet 117 is suitably at least about equal to the width W2 of the cutting assembly 111 and may be slightly greater than the width of the cutting assembly to facilitate hair cut by the assembly flowing into the inlet. As an example, the inlet 117 of the illustrated embodiment has a width W1 (FIG. 15a) of about 1.625 inches (about 4.13 cm). However, this width W1 may vary depending on the width W2 (FIG. 2) of the cutting assembly. A central panel 251 extends from the upstream end 105 of the housing 103 in generally parallel relationship with the top 253 of the housing such that the central panel and top of the housing together define the inlet chute 235 of the airway flow path 163. The opposite side of the central panel 251 and the bottom 261 of the housing 103 together define a compartment 263 in which the cutting assembly motor 205 is located.

The housing inlet 117 has a height H1 (as measured normal to the housing 103 between the top 253 of the housing the central panel 251 as illustrated in FIG. 15a) suitably in the range of about 0.25 inches (about 0.64 cm) to about 0.75 inches (about 1.9 cm), and more suitably in the range of about 0.375 inches (about 0.95 cm) to about 0.625 inches (about 1.59 cm). The height H1 of the housing inlet 117 illustrated in the embodiment of FIG. 3 is about 0.5 inches (1.27 cm). The housing inlet 117 has a cross-sectional area 267 (determined at the same location that the height H1 of the inlet is measured) suitably in the range of about 2.5 cm² to about 6.0 cm², and in one embodiment may be in the range of about 4.5 cm² to about 5.5 cm². As an example, the cross-sectional area 267 of the housing inlet 117 of the embodiment of FIG. 3 is about 5.0 cm².

The inlet chute 235 suitably extends downstream of the inlet 117 to the collection chamber 237 in the direction of the flow path 163 without making any sharp turns or bends, and more suitably provides a substantially straight flow path. For instance, the curvature of the inlet chute 235 of the illustrated embodiment is suitably very slight to facilitate smooth airflow through the inlet chute. As an example, the inlet chute 235 of the illustrated embodiment has a length L2 (FIG. 15) of at least about 1.0 inches (about 2.54 cm), and more suitably at least about 2.5 inches (about 6.35 cm). Although the inlet chute 235 of the illustrated embodiment is generally rectangular in cross section, the inlet chute can be configured to have a cross section that is other than rectangular without departing from the scope of the invention.

The inlet chute 235 may also be slightly tapered outward (e.g., in the width direction) so that it gradually increases in width and cross sectional area as it extends downstream from the inlet 117 to the collection chamber 237. For example, the inlet chute 235 may taper outward from the inlet 117 to the collection chamber 237 at an angle in the range of zero to about 25 degrees, and more suitably between about 1 and about 5 degrees. The cross sectional flow area 267 of the inlet chute 235 (measured normal to the top 253 of the housing 103 and the central panel 251 as illustrated in FIG. 15b) may increase from the housing inlet 117 to a cross-sectional area 271 downstream of the inlet toward the point at which the inlet chute opens into the collection chamber 237 of about 5.0 cm² to about 10.0 cm², and more suitably between about 8.0 cm² and about 10.0 cm².

The transition from the inlet chute 235 into the collection chamber 237 along the flow path 163 is marked by a substantial increase in the airway's 115 cross sectional flow area. The top 281 of the collection chamber 237 is suitably defined by a gently curved portion of the housing access panel 121 and the bottom 283 of the collection chamber 237 is suitably distended to increase the volume of the collection chamber as it extends downstream of the inlet chute 235. The sides 285 of the collection chamber 237 suitably taper gradually outward from the inlet chute 235 to the downstream end 291 of the collection chamber (e.g., adjacent the vacuum source 109).

In one embodiment, the flow path 163 of the airway 115, and more particularly the collection chamber portion 293 of the flow path 163, has a maximum cross-sectional area 295 (as illustrated in FIG. 15c) in the range of about 9.7 cm² to about 18.5 cm², and more suitably in the range of about 14.0 cm² to about 18.5 cm². As an example, in the illustrated embodiment the maximum cross-sectional area 295 of the flow path 163 of the airway 115 is about 16 cm². It is understood, however, that the maximum cross-sectional area 295 of the flow path 163 of the airway 115 may be greater or less than the above recited range. Accordingly, the maximum cross-sectional area 295 of the flow path 163 of the airway 115 may be more suitably expressed as a ratio relative to the cross-sectional area 297 of the housing 103 taken at the maximum cross-sectional area 295 of the flow path 163 of the airway 115, with a larger ratio indicating a relatively more efficient use of the interior space of the housing 103.

In a particularly suitable embodiment, the ratio of the maximum cross-sectional area 295 of the flow path 163 of the airway 115 to the cross-sectional area 297 of the housing 103 taken at the location of the maximum cross-sectional area of the flow path of the airway is in the range of about 0.5 to 1.00, more suitably in the range of about 0.65 to about 1.00, and even more suitably in the range of about 0.80 to about 1.00. As an example, the cross-sectional area 297 of the housing of the illustrated embodiment as measured at the location of the maximum cross-sectional area 295 of the flow path 163 of the airway 115 (FIG. 15c) is about 22 cm², providing a ratio of about 0.85.

In another embodiment, the maximum cross-sectional area 295 of the flow path 163 of the airway 115 (and more particularly, in the illustrated embodiment, of the collection chamber portion 293 of the flow path 163) may be expressed as a ratio relative to the size of the vacuum fan 141. For example, the ratio of the maximum cross-sectional area 295 of the flow path 163 of the airway 115 to the cross sectional area of the vacuum fan 141 (i.e., Π·(D1/2)²) is suitably in the range of about 0.7 to about 5.0. In the particular embodiment shown in FIG. 3, for example, this ratio is about 1.2.

The maximum cross-sectional area 295 of the flow path 163 of the airway 115 may be further expressed relative to the overall length L1 (FIG. 15) of the housing 103. The length L1 of the housing 103 is defined herein as the longitudinal length of the projection of the housing onto a flat plane measured from the upstream most extent of the projection to the downstream most extent thereof, omitting the portion of the cutting assembly 111 that extends beyond the upstream end 105 of the housing and omitting the power cord 301 and boot 305 extending from the downstream end 107 of the housing. For example, the length L1 of the housing 103 is suitably in the range of about 12 cm to about 25 cm, and in the illustrated embodiment is about 21 cm. The ratio of the maximum cross-sectional area 295 of the flow path 163 of the airway 115 to the overall length L1 of the housing 103 is suitably at least about 0.5 cm²/cm, more suitably in the range of about 0.5 cm²/cm to about 1.5 cm²/cm, and even more suitably in the range of about 0.6 cm²/cm to about 1.2 cm²/cm. As an example, the ratio of the maximum cross-sectional area 295 of the flow path 163 of the airway 115 to the overall length L1 of the housing 103 of the illustrated embodiment is about 0.9 cm²/cm.

In another embodiment, the maximum cross-sectional area 295 of the flow path 163 of the airway 115 may be expressed relative to the cross-sectional area 267 of the housing inlet 117. In particular, the ratio of the maximum cross sectional area 295 of the flow path 163 of the airway 115 to the cross sectional area 267 of the housing inlet 117 may suitably be at least about 2, more suitably between about 2 and about 8, and still more suitably between about 2.5 and about 4.5.

The volume of the flow path 163 of the airway 115 extending from the inlet 117 to the vacuum source 109 is suitably relatively large, particularly in comparison to a displacement of the entire housing 103. The volume of the flow path 163 as used herein is the sum of the collection chamber 237 volume and inlet chute 235 volume, with the volume being determined by a water displacement test (e.g., by measuring the displacement of the apparatus 101 to the displacement of the apparatus when the volumes are filled with modeling clay). As an example, in one embodiment the flow path 163 suitably has a volume in the range of about 100 cm³ to about 200 cm³, and more suitably in the range of about 160 cm³ to about 200 cm³. As an additional example, the volume of the flow path 163 of the illustrated embodiment is approximately 200 cm³. It is understood, however, that the flow path 163 volume may be greater than or less than the above range, depending on the overall size of the housing (and hence the apparatus).

Accordingly, one suitable way to express the flow path 163 volume is as a ratio relative to the overall volume of the housing 103. As used herein the overall volume of the housing 103 refers to a displacement of the housing as determined by removing the power cord 301, boot 305, and cutting assembly 111, filling all cavities with modeling clay, and placing the filled housing into a measured container of water to determine the volume of water displaced by the housing. In one embodiment, the displacement of the housing 103 is suitably between about 300 cm³ and about 400 cm³, more suitably between about 350 cm³ and about 400 cm³, and even more suitably between about 370 cm³ and about 390 cm³. As an example, the displacement of the housing 103 of the illustrated embodiment is approximately 375 cm³.

The ratio of the flow path 163 volume to the displacement of the housing 103 is suitably in the range of about 0.25 to about 0.67, and more suitably in the range of about 0.4 to about 0.6. As an example the ratio of the flow path 163 volume to the housing 103 displacement of the illustrated embodiment is about 0.53. The volume of the collection chamber 237 may suitably comprise at least about 50 percent of the volume of the flow path 163, more suitably in the range of about 50 percent to about 80 percent, and even more suitably in the range of about 60 percent to about 75 percent. In the illustrated embodiment, the collection chamber 237 volume comprises approximately 69 percent of the flow path 163 volume.

The geometry of the flow path 163 of the airway 115(e.g., from the housing inlet 117 to the vacuum source 109) is suitably free of any sharp bends or turns along the flow path, and in particular is relatively straight. One way to express this is in terms of the curvature of a median line 333 that extends along the flow path 163 of the airway 115. As used herein, the median line 333 of the flow path 163 of the airway 115 is determined by reference to the geometric configuration of the airway rather than by reference to the airflow (which may be smooth or turbulent). The median line 333 may suitably be a curve of best fit of data points along the geometric center of the airway 115.

In some instances the median line 333 may be plotted as a curve of best fit for the centers 341 of a series of circles 343 inscribed at various locations in the airway 115 along a cross section through the middle of the airway, as shown in FIG. 5. The centers 341 of the circles 343 are equidistant between opposing surfaces of the housing 103 that define the airway 115. In some cases, such as if the airway is asymmetric, resort to more sophisticated mathematics may be needed to generate data used to determine the median line.

In general, the median line may be expressed as a polynomial function of the form:
f(x)=a₀+a₁x+a₂x² . . . +aⱼx^{j}

where the coefficients a₀ through aⱼ are solved to minimize error between the line and the data. The order of the polynomial should be selected based on evaluation of the general shape of the airway so the median line can be correlated to the overall shape of the airway and so localized irregularities, which are not reflective of overall trends, are smoothed out. Increasing the order of the polynomial increases the number of inflection points in the median line. Thus, the order of the polynomial should be selected to allow for a suitable number of inflection points in the median line to characterize the overall curvature of the airway. Accordingly, the order of the polynomial used to define the curve of best fit can vary depending on the geometry of the airway.

Referring to FIG. 5, for example, a third order polynomial, which allows for one inflection point 351, is suitable for characterizing the airway 115 of the embodiment shown in the drawings because the median line 333 generated by curve fitting the data with a third order polynomial is representative of all the overall directional changes in the flow path 163 of the airway 115. On the other hand, use of a higher order polynomial will generally result in over-fitting the curve to the data. This may give a false impression that there is a sharp directional change in the airway. For example, the relatively small steps 253 on the interior of the housing 103, which have little impact on the direction of airflow, could impart a squiggle into a curve derived from higher order polynomial curve fitting, falsely suggesting that there is one or more turns in the airway 115 in the vicinity of the steps 353. When a third order polynomial is used to curve fit the data, the data from adjacent the step is given some weight, but the median line 333 is not required to pass through each data point (e.g., the median line 333 can bypass data points in the vicinity of the steps 353) and the curve is representative of the overall configuration of the airway 115.

Referring to FIG. 3, the median line 333 may suitably be approximately straight as it passes through the inlet chute 235. The median line 333 may suitably have an increasing curvature at the transition from the inlet chute 235 to the collection chamber 237 (e.g., bending slightly toward the bottom 283 of the collection chamber). The median line 333 suitably has an inflection point 351 near the upstream end 361 of the collection chamber 237, e.g., where the flow path 163 of the airway 115 transitions from the inlet chute 235 into the enlarged collection chamber. Downstream of the inflection point 351, the median line 333 suitably re-curves back toward the orientation of the median line at the inlet 117. Thus, the median line 333 of the embodiment shown in the drawings may be characterized as a very gentle S-curve extending from the inlet 117 to the vacuum source 109.

Notably, the median line 333 of the embodiment shown in the drawings is relatively straight. For example, the median line 333 may not change direction by more than about 60 degrees along the length of the flow path 163 of the airway 115 from the housing inlet 117 to the vacuum source 109. More suitably, the median line 333 does not change by more than about 30 degrees along the flow path 163 of the airway 115, and even more suitably the median line does not change by more than about 15 degrees along the flow path of the airway.

With particular reference now to FIGS. 3, 4 and 7, the hair clipping apparatus 101 also suitably comprises a filter member 371 disposed in the flow path 163 of the airway 111, and more suitably in the collection chamber 237 thereof, to prevent hair clippings from entering the vacuum source 109. More suitably, the filter member 371 is particularly configured to define an interior pocket 373 for collecting and retaining hair clippings within the housing 103 while still allowing air to flow therethrough for exhaustion from the housing via the housing exhaust 119. In the illustrated embodiment, the filter member 371 comprises a generally cradle-shaped basket 375 releasably secured to the inner surface of the access panel 121 such that the access panel forms a portion of the filter member.

The basket 375 of the filter member 371 defines a downstream end panel 377 of the filter member that suitably extends at least in part transverse to the direction of the flow path 163, a bottom panel 379 of the filter member extending upstream from the downstream end panel generally parallel to the direction of the flow path 163, and an upstream end panel 381 of the filter member. The bottom panel 379 of the filter member 371 is spaced from the housing access panel 121 such that the bottom panel, downstream end panel 377 and housing access panel 121 together define the interior pocket 373 of the filter member for collecting and retaining hair clippings.

As illustrated in FIG. 3, the upstream end panel 381 of the filter member 371 angles generally upward and upstream from the bottom panel 379 to seat generally flush with the central panel 251 within the housing 103 at the transition of the inlet chute 235 into the collection chamber 237. Accordingly, the upstream end panel 381 and housing access panel 121 together define an inlet 385 of the filter member 371 through which hair clippings and air in the flow path 163 flow into the interior pocket 373 of the filter member. In particular, because the upstream end 381 of the filter member seats flush with the central panel 251 within the housing 103, substantially all of the air and hair clippings flowing along the flow path 163 of the airway 115 suitably flow into the interior pocket 373 of the filter member 371.

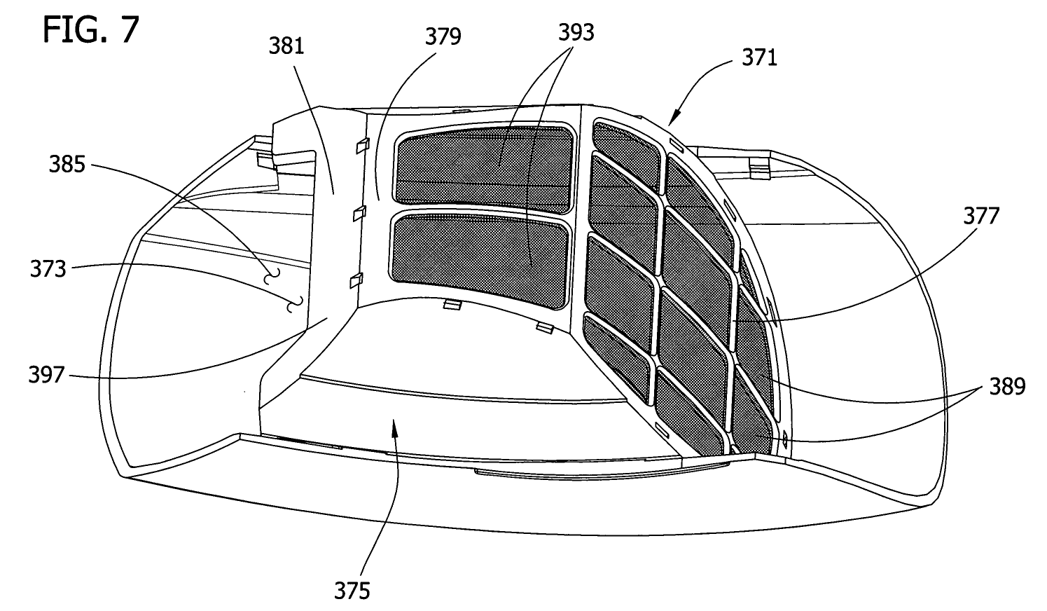

Referring primarily to FIGS. 4 and 7, the downstream end panel 377 of the filter member 371 is of a generally frame construction having one or more discrete filters 389 constructed of a gas permeable filter material (e.g., a mesh screen) sized to prevent hair from passing therethrough. The downstream end panel 377 of the illustrated embodiment abuts against the access panel 121 at its downstream most extent and is suitably sloped, or angled upstream and downward relative to the flow path 163 as the panel 377 extends upstream from its abutment against the access panel 121. Accordingly, the discrete filters 389 of the downstream end panel 377 of the filter member 371 are oriented within the flow path 163 to have a transversely extending component (i.e., extending across the flow path). It is contemplated that the downstream end panel may be other than sloped as in the illustrated embodiment, and may even extend normal to the access panel 121 transversely across the flow path 163 of the airway 115, without departing from the scope of the invention.

The bottom panel 379 of the filter member 371 is also of a general frame construction having one or more discrete filters 393 constructed of a gas permeable filter material (e.g., a mesh screen), suitably the same material as the gas permeable filters of the downstream end panel 377 of the filter member. The bottom panel filters 393 suitably extend generally parallel to the flow path 163 of the airway 115 such that air flowing along the flow path into the interior pocket 373 of the filter member 371 passes through the bottom panel 379 of the filter member in a direction generally transverse to the direction of the flow path 163. The upstream end panel 381 of the filter member 371 is generally solid but may otherwise also comprise one or more gas permeable filters. The upward angle of the upstream end panel 381 relative to the bottom panel 379 generally provides a lip 397 at the inlet of the filter member pocket 373 to inhibit hair against falling out of the pocket as the filter member 371 is removed from the apparatus 101 for emptying of the hair clippings.

The volume of the filter member pocket 373 is suitably relatively large in comparison to the collection chambers of prior art beard and mustache trimmers. For example, the volume of the filter member pocket is suitably at least about 72 cm³, more suitably in the range of about 72 cm³ to about 150 cm³, and even more suitably in the range of about 105 cm³ to about 135 cm³. For example, in the embodiment shown in FIG. 3, the volume of the filter pocket member 373 is about 120 cm³. The volume of the filter pocket member is also relatively large in comparison to the displacement of the housing 103 (as measured by the displacement test described above). Thus, the ratio of the volume of the filter member pocket 373 to the displacement of the housing 103 is suitably at least about 0.2, more suitably in the range of about 0.2 to about 0.5, and even more suitably in the range of about 0.30 to about 0.35. The ratio of the volume of the filter pocket member 373 to the displacement of the housing in the embodiment shown in FIG. 3, for instance, is about 0.32.

It is understood that the number of discrete filters 389, 393 of the downstream end panel 377 of the filter member 371 and/or of the bottom panel 379 may be other than as shown in the drawings without departing from the scope of this invention. It is also contemplated that the downstream end panel 377 and the bottom panel 379 of the filter member 371 may comprises a single (e.g., unitary) filter, without the illustrated frame construction, and remain within the scope of this invention.

An on/off switch 401 is provided on the housing 130 generally adjacent its upstream end 105 for turning the apparatus on and off. In the illustrated embodiment, a single switch 401 is used whereby in the on position both the vacuum source 109 and cutting assembly 111 motors 205, 181 are operated. However, it is understood that separate switches (not shown) may be provided for independently operating the cutting assembly and vacuum source, respectively. Alternatively, a three-way switch may be provided with three positions corresponding to an off position, a vacuum source 109 on position in which only the vacuum source is operated, and a full on position in which both the vacuum source and cutting assembly 111 are operated.

It is also contemplated that the vacuum source 109 may be operated in a reverse direction so as to produce a reverse airflow (e.g., air is drawn into the housing 103 at exhaust 199 and blown out of the housing inlet 117). In such an embodiment, the operator can empty the filter member 371 and then blow remaining hair clippings off the subject of the cut or otherwise away from the work area.

In operation of the apparatus 101, the access panel 121 (and hence the filter member 371) is releasably secured to the housing 103 to position the filter member in the flow path 163 of the airway 115. The apparatus 101 is grasped in one hand by the operator, e.g., with the operator's palm down against the access panel 121 and the operator's fingers extending around the sides 285 of the collection chamber 237. The apparatus 101 is held in a generally horizontal orientation, or slightly tilted angle, and the switch 401 is moved to its on position to operate the vacuum source 109 and cutting assembly 111. Upon operation of the vacuum source 109, air is drawn into the housing 103 via the housing inlet 117 and flows along the airway 115 from the inlet, along the flow path 163 of the airway into the interior pocket 373 of the filter member 371, through the downstream end panel 377 of the filter member generally in the direction of the flow path 163 and also through the bottom panel 379 of the filter member generally in a direction transverse to the direction of the flow path 163, to the vacuum source 109 and then out from the housing via the exhaust 119.

The cutting assembly 111 is moved into contact with the hairs to be cut to cut the hairs, thereby producing hair clippings. The hair clippings become entrained in the air being drawn into the housing 103 and are drawn along the flow path 163 of the airway 115 into the interior pocket 373 of the filter member 371. As the air flow enters the enlarged collection chamber 237 of the airway 115, the air flow velocity decreases due to the relatively larger cross sectional area of the collection chamber. As a result, the hair clippings tend to fall lower in the airstream due to gravity. With the particular filter member 371 configuration illustrated in FIGS. 1-7, the hair clippings tend to build up within the pocket 373 of the filter member in sloped layers with the first or underlying layer forming generally the intersection between the bottom panel 379 and the sloped downstream end panel 377 of the filter member. However, the precise manner in which the hair clippings are collected in the filter member 371 will vary depending on the characteristics of the hair being cut and the angle at which the apparatus is held during cutting.

The filter member 371 configuration also provides for little drop-off in the flow rate of air through the airway 115, and in particular through the flow path 163 of the airway, as the interior pocket 373 of the filter member 371 fills with hair clippings. For example, in one embodiment the rate of airflow through the airway 115 when the interior pocket 373 of the filter member is substantially filled with hair clippings is suitably at least about 80 percent of the rate of airflow through the airway when the filter member is empty, more suitably at least about 90 percent, and even more suitably at least about 95 percent. Likewise, there is suitably little drop-off in the vacuum pressure that may be generated by the vacuum source 109 as the filter member 371 fills with hair clippings. In particular, in one embodiment the vacuum source 109 suitably produces a vacuum pressure (expressed in inches of water gauge) in the airway 115 when the filter member 371 is filled with hair clippings that is at least about 80 percent, and more suitably at least about 85 percent, of the vacuum pressure in the airway when the filter member is empty.

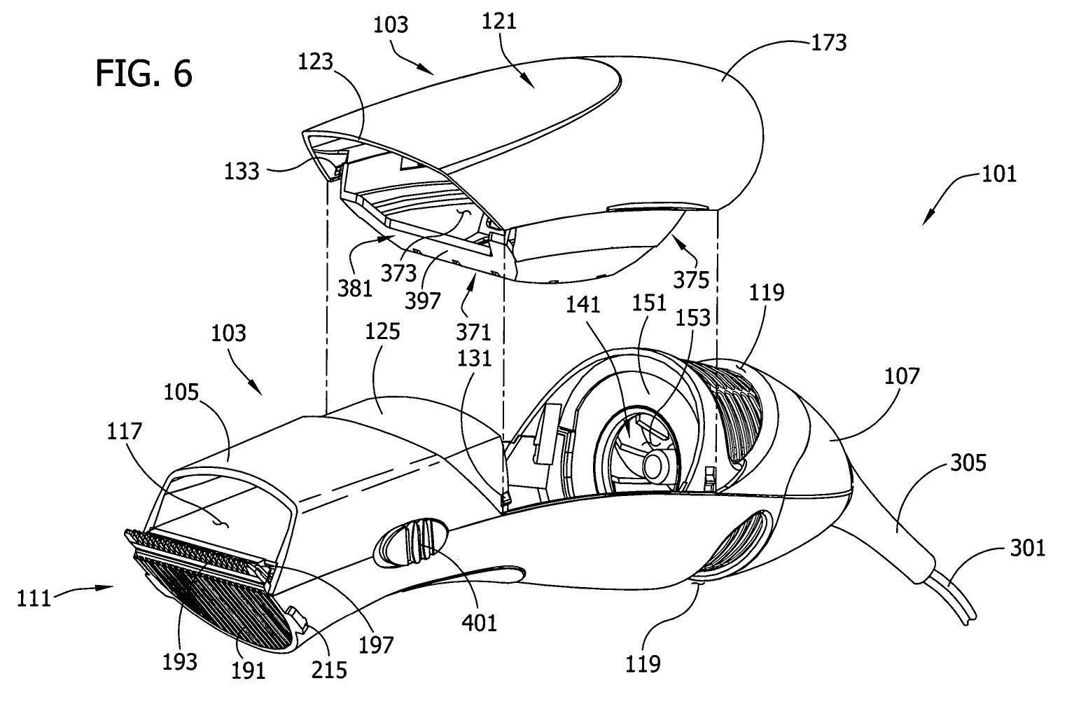

Once the filter member 371 is filled with hair clippings, the access panel 121 (and hence the filter member) is removed from the housing 103 as shown in FIG. 6 and the hair clippings are dumped out of the filter member. The access panel 121 (and hence the filter member 371) are replaced on the housing 103 and further cutting may continue. The vacuum source 109 and cutting assembly 111 may be left on during cleaning of the filter member 371, or may more suitably be turned off.

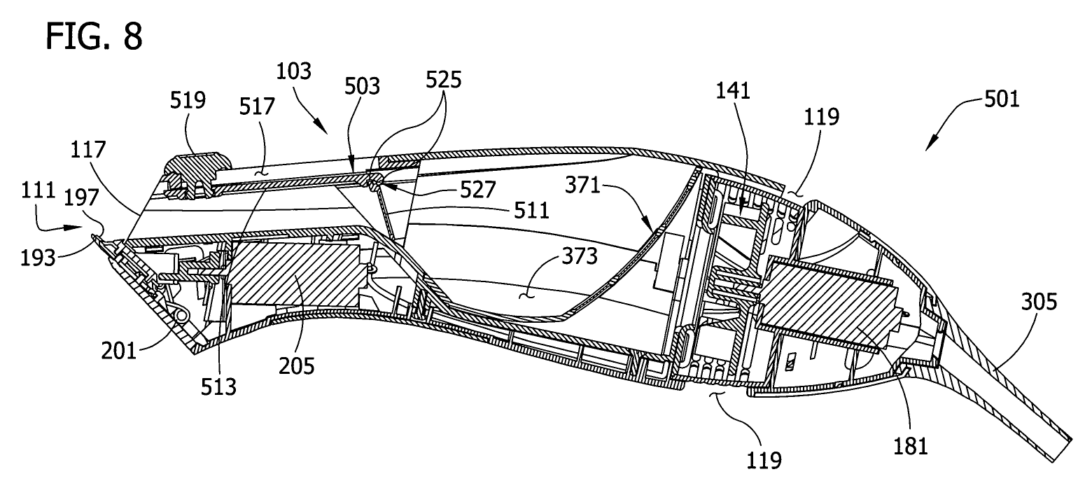

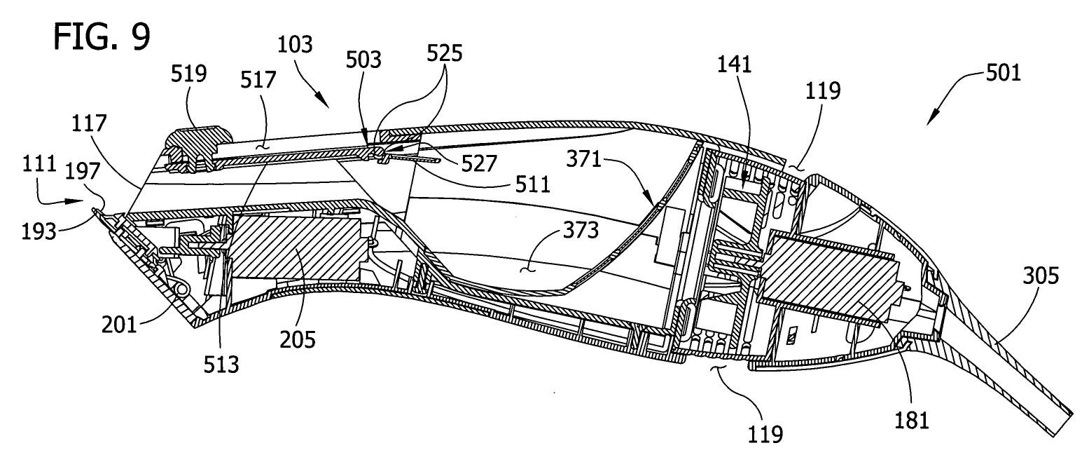

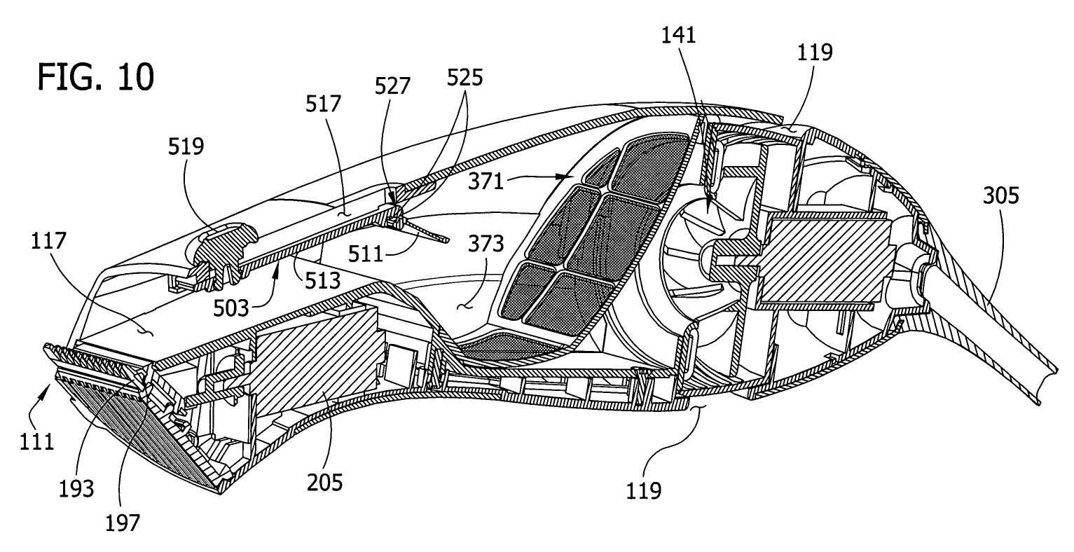

FIGS. 8-14 illustrate a hair clipping apparatus of a second embodiment of the present invention, generally designated 501. The construction and operation of the apparatus is substantially the same as the apparatus of FIGS. 1-7, with the addition of a compaction device 503 for compacting hair clippings 505 that accumulate in the interior pocket 373 formed by the filter member 371. With particular reference to FIG. 8, the compaction device 503 comprises a flapper plate 511 mounted in the airway 115, and in particular in the flow path 163 of the airway, at the transition from the inlet chute 235 into the collection chamber 237. The flapper plate 511 is pivotally mounted on the downstream end of a slider 513 that is slidable within the housing 103, e.g., in the inlet chute 235 of the flow path 163 of the airway 115, in a longitudinal direction (i.e., an upstream/downstream direction) generally parallel to the flow path of the airway. A corresponding slot 517 is formed in the top 253 of the housing 103 and accommodates an actuator 519 (e.g., thumb button) that is secured to the slider 513 and accessible from outside the housing 103 for selectively operating the slider. The flapper plate 511 is free to rotate between a first, closed position (FIG. 8) in which the flapper plate obstructs the airway 115 and a second, open position (FIGS. 9 and 10) in which the flapper plate does not obstruct the airway. Pivotal movement of the flapper plate 511 beyond the range between the first position and second position is suitably limited by a pair of stops 525 in the mounting apparatus 527 (e.g., hinge) used to mount the flapper plate to the slider 513.

FIG. 8 illustrates one possible state of the compacting apparatus 503 when the vacuum source 109 is turned off, such as after operating the apparatus 501 to clip hair and accumulate hair clippings 505 within the filter member 371. Because there is no airflow through the airway 115. The weight of the flapper plate 511 causes the free end of the flapper plate to swing down toward the opposite side of the airway 115. In this position, the flapper plate 511 inhibits hair clippings 505 that have accumulated in the filter member 371 against falling out of the clippers 501 through the housing inlet 117. When the vacuum source 109 is activated, the pressure differential and eventually the airflow through the flow path 163 of the airway 115 causes the flapper plate 511 to swing up into the position shown in FIGS. 9 and 10. The airflow through the airway 115 is sufficiently strong to keep the flapper plate 511 in its open position as long as the vacuum source 109 is active.

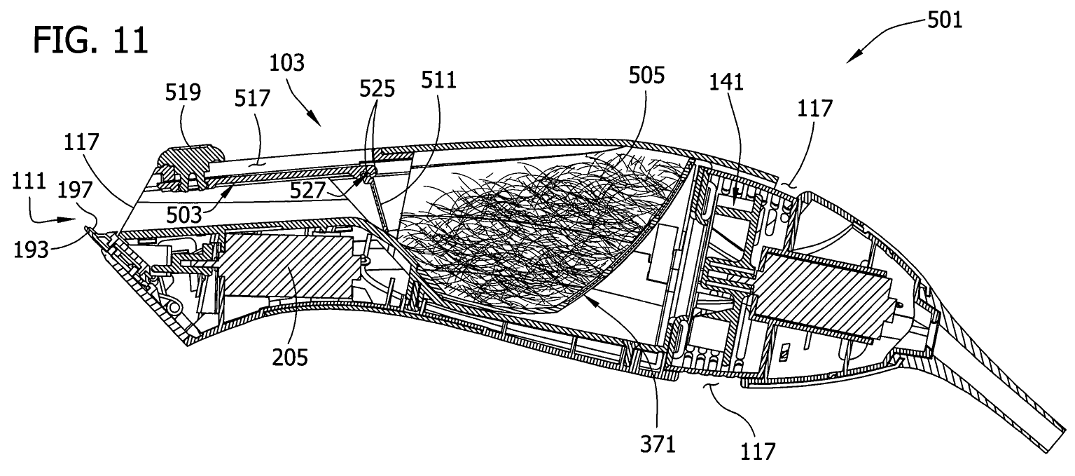

During operation of the apparatus 501 to cut hair, hair clippings 505 are drawn into and retained within the pocket 373 of the filter member 371. To decrease the frequency with which the filter member 371 must be emptied, the compaction device 503 may be used as illustrated in the sequence shown in FIGS. 11-14 to compact the hair clippings 505 in the filter member to thereby make room in the filter member pocket 373 for additional hair clippings. FIG. 11 shows the apparatus 501 with the vacuum source 109 turned off after operation during which the filter member pocket 373 has become filled with hair clippings 505. The operator may actuate the slider 513 by moving the actuator 519 (e.g., the thumb button) longitudinally along the slot 517 downstream toward the filter member 371, as shown in FIGS. 12 and 13. As the slider 513 moves farther downstream in the airway 115, the flapper plate 511 enters the filter member pocket 373 and pushes against the accumulated hair clippings 505 in the pocket. Pivotal movement of the flapper plate 511 is limited by one of the stops 525 in the mounting apparatus 527. Accordingly, the flapper plate 511 compacts the hair clippings 505 toward the downstream end 377 of the filter member pocket 373, clearing additional room near the upstream end (e.g., the inlet 385) of the filter member pocket 373 for additional hair clippings. The operator then slides the actuator 519 upstream back to its initial position as shown in FIG. 14. In this position, the apparatus 501 may be operated (with the cutting assembly 111 and vacuum source 109 operating) to cut additional hairs and draw the hair clippings 505 into the filter member 371. The process may be repeated as desired to further pack hair clippings 505 even more densely in the filter member pocket 373.

While the compaction device 503 illustrated in FIGS. 8-14 is a manually operable compaction device, it is contemplated that the compaction device may be motorized or otherwise automated without departing from the scope of this invention.

When introducing elements of the present invention or preferred embodiments thereof, the articles “a”, “an”, “the”, and “said” are intended to mean that thee are one or more of the elements. The terms “comprising”, “including”, and “having” are intended to be inclusive and mean that there may be additional elements other than the listed elements.

As various changes could be made in the above constructions and methods without departing from the scope of the invention, it is intended that all matter contained in the above description and shown in the accompanying drawings shall be interpreted as illustrative and not in a limiting sense.

What is claimed is:

1. Hand-held apparatus for clipping hair, said apparatus comprising:
a housing having an upstream end, a downstream end, an inlet at said upstream end for receiving air and hair clippings into the housing, an exhaust downstream of the inlet for exhausting air from the housing, and an airway extending within the housing from said inlet to said exhaust for directing air flow through the housing;
a vacuum source disposed in the airway intermediate the inlet and the exhaust and defining a flow path along said airway through which air flows generally in the direction of the flow path from the housing inlet to the vacuum source, said vacuum source being operable to draw air into the housing through said inlet and along said airway including said flow path for subsequent exhaustion from the housing through said exhaust;
a cutting assembly comprising at least one cutting blade disposed exterior of the airway in spaced relationship with the housing inlet such that hair clippings produced by the cutting assembly are drawn through the housing inlet into the airway for flow along said flow path toward said vacuum source; and
a filter member disposed in the airway along said flow path between the inlet and the vacuum source to inhibit hair clippings that have been drawn into the airway from flowing to the vacuum source;
the housing inlet having a cross-sectional area, the flow path between said inlet and the vacuum source having a maximum cross-sectional area downstream of said inlet, said maximum cross-sectional area of the flow path being greater than the cross-sectional area of the inlet, the housing having a cross-sectional area at said maximum cross-sectional area of the flow path, a ratio of the maximum cross-sectional area of the flow path to the cross-sectional area of the housing at said maximum cross-sectional area of the flow path being at least about 0.7.

2. The apparatus set forth in claim 1 wherein the ratio of the maximum cross-sectional area of the flow path to the cross-sectional area of the housing at said maximum cross-sectional area of the flow path airway is at least about 0.80.

3. The apparatus set forth in claim 1 wherein the ratio of the maximum cross-sectional area of the flow path to the cross-sectional area of the inlet is at least about 2.

4. The apparatus set forth in claim 3 wherein the ratio of the maximum cross-sectional area of the flow path to the cross-sectional area of the inlet is between about 2 and about 8.

5. The apparatus set forth in claim 1 wherein the filter member is configured to collect and retain hair clippings therein while allowing air flowing along the flow path to pass through the filter member.

6. The apparatus set forth in claim 5 wherein the filter member is configured and arranged in the flow path such that substantially all of the air and hair clippings that flow into the housing inlet and along the flow path flow into the filter member.

7. The apparatus set forth in claim 5 wherein the filter member comprises a first panel extending at least in part transverse to the direction of the flow path and a second panel extending generally parallel to the direction of the flow path, the first and second panels of the filter member together at least in part defining an interior pocket of the filter member, the filter member being arranged within the flow path such that air flows into the interior pocket of the filter member generally in the direction of the flow path, a portion of the air flows out of said pocket generally in the direction of the flow path through said first panel and another portion of the air flows out of said pocket in a direction generally transverse to the direction of the flow path through said second panel.

8. The apparatus set forth in claim 5 further comprising a compaction device disposed within the flow path of the airway for at least one of selectively and intermittently compacting hair clippings accumulated in the filter member.

9. The apparatus set forth in claim 1 wherein the flow path of the airway has a median line extending along said flow path from the inlet to the vacuum source, said median line being free from deviations of more than about 60 degrees along said flow path.

10. The apparatus set forth in claim 9 wherein said median line is free from deviations of more than about 30 degrees along said flow path.

11. The apparatus set forth in claim 10 wherein said median line is free from deviations of more than about 15 degrees along said flow path.

12. The apparatus set forth in claim 1 wherein the apparatus is operable between a first mode in which the vacuum source and cutting assembly are inoperative, a second mode in which the vacuum source and cutting assembly are both operative, and a third mode in which the vacuum source is operative while the cutting assembly is inoperative.

13. Hand-held apparatus for clipping hair, said apparatus comprising:
a housing having an upstream end, a downstream end, an inlet at said upstream end for receiving air and hair clippings into the housing, an exhaust downstream of the inlet for exhausting air from the housing, and an airway extending within the housing from said inlet to said exhaust for directing air flow through the housing;
a vacuum source disposed in the airway intermediate the inlet and the exhaust and defining a flow path along said airway through which air flows generally in the direction of the flow path from the housing inlet to the vacuum source, said vacuum source being operable to draw air into the housing through said inlet and along said airway including said flow path for subsequent exhaustion from the housing through said exhaust;
a cutting assembly comprising at least one cutting blade disposed exterior of the airway in spaced relationship with the housing inlet such that hair clippings produced by the cutting assembly are drawn through the housing inlet into the airway for flow along said flow path toward said vacuum source; and
a filter member disposed in the airway along said flow path between the inlet and the vacuum source to inhibit hair clippings that have been drawn into the airway from flowing to the vacuum source;
the housing inlet having a cross-sectional area, the flow path of the airway having a maximum cross-sectional area downstream of said inlet, said maximum cross-sectional area of the flow path being greater than the cross-sectional area of the housing inlet, the housing having a length, a ratio of the maximum cross-sectional area of the flow path to the length of the housing being at least about 0.5 cm²/cm.

14. The apparatus set forth in claim 13 wherein the ratio of the maximum cross-sectional area of the flow path to the length of the housing is in the range of about 0.5 cm²/cm to about 1.2 cm²/cm.

15. The apparatus set forth in claim 14 wherein the ratio of the maximum cross-sectional area of the flow path to the length of the housing is about 0.9 cm²/cm.

16. The apparatus set forth in claim 1 wherein the ratio of the maximum cross-sectional area of the flow path to the cross-sectional area of the inlet is at least about 2.

17. The apparatus set forth in claim 16 wherein the ratio of the maximum cross-sectional area of the flow path to the cross-sectional area of the inlet is between about 2 and about 8.

18. The apparatus set forth in claim 13 wherein the filter member comprises a first panel extending at least in part transverse to the direction of the flow path and a second panel extending generally parallel to the direction of the flow path, the first and second panels of the filter member together at least in part defining an interior pocket of the filter member for collecting and retaining hair clippings in the filter member, said filter member being arranged within the flow path such that air flows into the interior pocket of the filter member generally in the direction of the flow path, a portion of the air flows out of said pocket generally in the direction of the flow path through said first panel and another portion of the air flows out of said pocket in a direction generally transverse to the direction of the flow path through said second panel.

19. The apparatus set forth in claim 13 wherein the flow path of the airway has a median line extending along said flow path from the inlet to the vacuum source, said median line being free from deviations of more than about 60 degrees along said flow path.

20. The apparatus set forth in claim 19 wherein said median line is free from deviations of more than about 30 degrees along said flow path.

21. The apparatus set forth in claim 20 wherein said median line is free from deviations of more than about 15 degrees along said flow path.

22. Hand-held apparatus for clipping hair, said apparatus comprising:
a housing having an upstream end, a downstream end, an inlet at said upstream end for receiving air and hair clippings into the housing, an exhaust downstream of the inlet for exhausting air from the housing, and an airway extending within the housing from said inlet to said exhaust for directing air flow through the housing;
a vacuum source disposed in the airway intermediate the inlet and the exhaust and defining a flow path along said airway through which air flows from the housing inlet to the vacuum source, said vacuum source comprising a vacuum fan having a cross-sectional area and being operable to draw air into the housing through said inlet and along said airway including said flow path for exhaustion from the housing through said exhaust;
a cutting assembly comprising at least one cutting blade disposed exterior of the airway in spaced relationship with the housing inlet such that hair clippings produced by the cutting assembly are drawn through the housing inlet into the airway for flow along said flow path toward said vacuum source; and
a filter member disposed in the airway along said flow path between the inlet and the vacuum source to inhibit hair clippings that have been drawn into the airway from flowing to the vacuum source;
the housing inlet having a cross-sectional area, the flow path of the airway having a maximum cross-sectional area downstream of said inlet, the maximum cross-sectional area of the flow path being greater than the cross-sectional area of the inlet, a ratio of the maximum cross-sectional area of the flow path to the cross sectional area of the vacuum fan being at least about 0.7.

23. The apparatus set forth in claim 21 wherein the ratio of the maximum cross-sectional area of the flow path to the cross sectional area of the vacuum fan is in the range of about 0.7 to about 5.0.

24. The apparatus set forth in claim 21 wherein the vacuum fan comprises an axial flow fan having a plurality of blades.

25. The apparatus set forth in claim 21 wherein the vacuum fan comprises a centrifugal fan having a plurality of vanes.

26. The apparatus set forth in claim 21 wherein the filter member comprises a first panel extending at least in part transverse to the direction of the flow path and a second panel extending generally parallel to the direction of the flow path, the first and second panels of the filter member together at least in part defining an interior pocket of the filter member for collecting and retaining hair clippings in the filter member, said filter member being arranged within the flow path such that air flows into the interior pocket of the filter member generally in the direction of the flow path, a portion of the air flows out of said pocket generally in the direction of the flow path through said first panel and another portion of the air flows out of said pocket in a direction generally transverse to the direction of the flow path through said second panel.

27. The apparatus set forth in claim 21 wherein the flow path of the airway has a median line extending along said flow path from the inlet to the vacuum source, said median line being free from deviations of more than about 60 degrees along said flow path.

28. Hand-held apparatus for clipping hair, said apparatus comprising:
a housing having an upstream end, a downstream end, an inlet at said upstream end for receiving air and hair clippings into the housing, an exhaust downstream of the inlet for exhausting air from the housing, and an airway extending within the housing from said inlet to said exhaust for directing air flow through the housing;
a vacuum source disposed in the airway intermediate the inlet and the exhaust and defining a flow path along said airway through which air flows generally in the direction of the flow path from the housing inlet to the vacuum source, said vacuum source being operable to draw air into the housing through said inlet and along said airway including said flow path for subsequent exhaustion from the housing through said exhaust;
a cutting assembly comprising at least one cutting blade disposed exterior of the airway in spaced relationship with the housing inlet such that hair clippings produced by the cutting assembly are drawn through the housing inlet into the airway for flow along said flow path toward said vacuum source; and
a filter member disposed in the airway along said flow path between the inlet and the vacuum source to inhibit hair clippings that have been drawn into the airway from flowing to the vacuum source;
the housing inlet having a cross-sectional area, the flow path of the airway having a maximum cross-sectional area downstream of said inlet, the maximum cross-sectional area of the flow path being greater than the cross-sectional area of the inlet, said flow path having a median line extending therethrough along said flow path from the inlet to the vacuum source, said median line being free from deviations of more than about 60 degrees along said flow path, the flow path of the airway defining a volume, the housing defining a displacement, a ratio of said flow path volume to said housing displacement being at least about 0.25.

29. The apparatus of claim 28 wherein the ratio of said flow path volume to said housing displacement is between about 0.25 and about 0.65.

30. The apparatus of claim 29 wherein the ratio of said flow path volume to said housing displacement being at least about 0.5.

31. Hand-held apparatus for clipping hair, said apparatus comprising:
a housing having an upstream end, a downstream end, an inlet at said upstream end for receiving air and hair clippings into the housing, an exhaust downstream of the inlet for exhausting air from the housing, and an airway extending within the housing from said inlet to said exhaust for directing air flow through the housing;
a vacuum source disposed in the airway intermediate the inlet and the exhaust and defining a flow path along said airway through which air flows generally in the direction of the flow path from the housing inlet to the vacuum source, said vacuum source being operable to draw air into the housing through said inlet and along said airway including said flow path for subsequent exhaustion from the housing through said exhaust;
a cutting assembly comprising at least one cutting blade disposed exterior of the airway in spaced relationship with the housing inlet such that hair clippings produced by the cutting assembly are drawn through the housing inlet into the airway for flow along said flow path toward said vacuum source; and
a filter member disposed in the airway along said flow path between the inlet and the vacuum source to inhibit hair clippings that have been drawn into the airway from flowing to the vacuum source, the filter member being configured to define an interior pocket of said filter member for collecting and retaining hair clippings, said filter member being removable from the housing for emptying hair clippings from said pocket, said pocket of said filter member having a maximum cross-sectional area along said flow path;
the housing inlet having a cross-sectional area, the maximum cross-sectional area of the filter member pocket along said flow path being greater than the cross-sectional area of the housing inlet, the housing having a cross-sectional area at said maximum cross-sectional area of the filter member pocket, a ratio of the maximum cross-sectional area of the filter member pocket to the cross-sectional area of the housing at said maximum cross-sectional area of the filter member pocket being at least about 0.40.

32. The apparatus set forth in claim 31 wherein the ratio of the maximum cross-sectional area of the filter member pocket to the cross-sectional area of the housing at said maximum cross-sectional area of the filter member pocket is between about 0.4 about 0.90.

33. The apparatus set forth in claim 32 wherein the ratio of the maximum cross-sectional area of the filter member pocket to the cross-sectional area of the housing at said maximum cross-sectional area of the filter member pocket is between about 0.70 about 0.75.

34. Hand-held apparatus for clipping hair, said apparatus comprising:
a housing having an upstream end, a downstream end, an inlet at said upstream end for receiving air and hair clippings into the housing, an exhaust downstream of the inlet for exhausting air from the housing, and an airway extending within the housing from said inlet to said exhaust for directing air flow through the housing;
a vacuum source disposed in the airway intermediate the inlet and the exhaust and defining a flow path along said airway through which air flows generally in the direction of the flow path from the housing inlet to the vacuum source, said vacuum source being operable to draw air into the housing through said inlet and along said airway including said flow path for subsequent exhaustion from the housing through said exhaust, the flow path of the airway having a median line extending along said flow path from the inlet to the vacuum source, said median line being free from deviations of more than about 60 degrees along said flow path;
a cutting assembly comprising at least one cutting blade disposed exterior of the airway in spaced relationship with the housing inlet such that hair clippings produced by the cutting assembly are drawn through the housing inlet into the airway for flow along said flow path toward said vacuum source; and
a filter member disposed in the airway along said flow path between the inlet and the vacuum source to inhibit hair clippings that have been drawn into the airway from flowing to the vacuum source, the filter member being configured to define an interior pocket of said filter member for collecting the hair clippings, said filter member being removable from the housing for emptying hair clippings from the pocket and being constructed and arranged in the flow path such that air flowing along the flow path flows into the filter member pocket generally in the direction of the flow path, said filter member being further configured to permit a portion of air that flows into the interior pocket of the filter member to pass out through the filter member generally in the direction of the flow path and to permit another portion of air that flows into the interior pocket of the filter member to pass out through the filter member generally in a direction transverse to the direction of the flow path.

35. The apparatus set forth in claim 34 wherein said median line is free from deviations of more than about 30 degrees along said flow path.

36. The apparatus set forth in claim 35 wherein said median line is free from deviations of more than about 15 degrees along said flow path.

37. Hand-held apparatus for clipping hair, said apparatus comprising:
a housing having an upstream end, a downstream end, an inlet at said upstream end for receiving air and hair clippings into the housing, an exhaust downstream of the inlet for exhausting air from the housing, and an airway extending within the housing from said inlet to said exhaust for directing air flow through the housing;
a vacuum source disposed in the airway intermediate the inlet and the exhaust and defining a flow path along said airway through which air flows generally in the direction of the flow path from the housing inlet to the vacuum source, said vacuum source being operable to draw air into the housing through said inlet and along said airway including said flow path for subsequent exhaustion from the housing through said exhaust;
a cutting assembly comprising at least one cutting blade disposed exterior of the airway in spaced relationship with the housing inlet such that hair clippings produced by the cutting assembly are drawn through the housing inlet into the airway for flow along said flow path toward said vacuum source;
a filter member disposed in the airway along said flow path between the inlet and the vacuum source to inhibit hair clippings that have been drawn into the airway from flowing to the vacuum source, the filter member being configured to define an interior pocket of said filter member for collecting and retaining hair clippings therein, said filter member being removable from the housing for emptying hair clippings from the pocket; and
a compaction device operable within the flow path of the airway to at least one of selectively and intermittently compact hair clippings collected and retained in the interior pocket of the filter member.

38. The apparatus of claim 37 wherein the compaction device comprises:
a slider mounted in the airway for sliding movement relative to the filter member generally in the direction of the flow path;
a flapper plate mounted on the slider and positionable within the interior pocket of the filter member upon movement of the slider relative to the filter member, said flapper plate being configured for compacting at least some hair clippings in the interior pocket of the filter member upon movement of the slider relative to filter member.

39. The apparatus of claim 37 wherein the compaction device is a manually operated device for selectively compacting hair clippings in the interior pocket of the filter member.

40. Hand-held apparatus for clipping hair, said apparatus comprising:
a housing having an upstream end, a downstream end, an inlet at said upstream end for receiving air and hair clippings into the housing, an exhaust downstream of the inlet for exhausting air from the housing, and an airway extending within the housing from said inlet to said exhaust for directing air flow through the housing;
a vacuum source disposed in the airway intermediate the inlet and the exhaust and defining a flow path along said airway through which air flows generally in the direction of the flow path from the housing inlet to the vacuum source, said vacuum source being operable to draw air into the housing through said inlet and along said airway including said flow path for subsequent exhaustion from the housing through said exhaust;
a cutting assembly comprising at least one cutting blade disposed exterior of the airway in spaced relationship with the housing inlet such that hair clippings produced by the cutting assembly are drawn through the housing inlet into the airway for flow along said flow path toward said vacuum source; and
a filter member disposed in the airway along said flow path between the inlet and the vacuum source to inhibit hair clippings that have been drawn into the airway from flowing to the vacuum source, the filter member being configured to define an interior pocket of said filter member for collecting and retaining hair clippings therein, said filter member being removable from the housing for emptying hair clippings from the pocket,
wherein the housing defines a displacement and the interior pocket of the filter member has a volume, the ratio of the volume of the interior pocket of the filter member to the displacement of the housing being at least about 0.2.

41. The apparatus as set forth in claim 40 wherein the ratio of the volume of the filter member pocket to the displacement of the housing is in the range of about 0.2 to about 0.5.

42. The apparatus as set forth in claim 41 wherein the ratio of the volume of the filter member pocket to the displacement of the housing is in the range of about 0.3 to about 0.35.
